(19) United States
(12) Patent Application Publication
(10) Pub. No.: US 2025/0147193 A1
(43) Pub. Date: May 8, 2025

(54) PRECISE ATTITUDE DETERMINATION AND POSITIONING SYSTEM

(71) Applicant: NatureEye, Inc., Sunny Isles Beach, FL (US)

(72) Inventor: Matthew Rabinowitz, San Francisco, CA (US)

(21) Appl. No.: 18/955,425

(22) Filed: Nov. 21, 2024

Related U.S. Application Data
(63) Continuation of application No. PCT/US23/67811, filed on Jun. 2, 2023.
(60) Provisional application No. 63/348,845, filed on Jun. 3, 2022.

(51) Int. Cl. G01S 19/55; G01S 19/36; G01S 19/44

(52) U.S. Cl. CPC G01S 19/55; G01S 19/36; G01S 19/44

(57) ABSTRACT

A system rapidly orients a phased array antenna with respect to a transmitter by performing carrier phase tracking, resolving integer cycle ambiguities for multiple baselines in the array antenna, and solving parameters describing the platform orientation. The phased array antenna may be placed on a stationary platform, such as a base station, or on a mobile platform, such as a drone or a car.

### BACKGROUND

It has been described how Low Earth Orbit (LEO) satellites can be used in differential navigation systems for centimeter level positioning using carrier phase tracking of LEO satellites to resolve cycle ambiguities. Sec Rabinowitz, Matthew. “A Differential Carrier Phase Navigation System for Combining GPS with Low Earth Orbit Satellites for Rapid Resolution of Integer Cycle Ambiguities”. Ph.D. Dissertation, December 2000, UMI Number 3000087. https://web.stanford.cdu/group/scpnt/gpslab/pubs/theses/MatthewRabinowitzThesis01.pdf (hereinafter “Rabinowitz 2000” and hereby incorporated by reference). It has also previously been described how non-GPS communication signals, such as analog or digital television signals, can be used for precise positioning to replace or augment GPS (Scc Bradford Parkinson (Editor) and James Spilker (Editor). Global Positioning System: Theory & Applications, Volumes I & II. (Progress in Aeronautics and Astronautics). January 1996. Volume 164. ISBN-10:1563471078), when the timing of those signals is known or tracked by a reference receiver with a stable reference clock (see Rabinowitz, M. and Spilker, J. “An internet-based system for achieving reliable indoor positioning using broadcast television synchronization signals”. IEEE Transactions on Broadcasting, 2005; 51:51-61, and Rabinowitz, M. and Spilker, J. “Augmenting GPS with television signals for reliable indoor positioning”. Navigation: J Institute of Navigation 2004; 51: Winter 2004).

It also has been shown how a dual polarization antenna can be used to determine direction of arrival for GPS signals (See Lo, Sherman, et al, “Developing a Dual Polarization Antenna (DPA) for High Dynamic Applications”, ION ITM 2020 SP Spoof Detect SDR rv6, http://wcb.stanford.cdu/group/scpnt/gpslab/pubs/papers/Lo_ION_ITM_2020_DPA_SDR.pd f). It also has been shown how a directional beam-forming antenna can be used to better track satellite signals in a jamming environment (See Chen, Yu-Hsuan, et al, “Validation of a Controlled Reception Pattern Antenna (CRPA) Receiver Built from Inexpensive General-purpose Elements During Several Live Jamming Test Campaigns”, ION ITM 2013, http://web.stanford.edu/group/scpnt/gpslab/pubs/papers/Chen_IONI™_2013.pdf). It also has been described how attitude determination can be achieved with a multi-antenna GPS receiver (See Kaylen, Leen Vander, “Attitude Determination Methods Used in the PolaRx2® Multi-antenna GPS Receiver”, Proceedings of the 18th International Technical Meeting of the Satellite Division of The Institute of Navigation (ION GNSS 2005), Sep. 13-16, 2005, https://www.ion.org/publications/abstract.cfm?articleID=6202). It also has been shown how to estimate of the attitude of unmanned aerial vehicles (UAV) by taking advantage an antenna array structure on the UAV, using estimated phase delays of the impinging signals over the antenna array, to improve estimates of inertial measurement units. (See Da Costa, J. P. C. L., et al., “Attitude determination for unmanned aerial vehicles via an antenna array”, 2012 International ITG Workshop on Smart Antennas (WSA). Date of Conference: 07-8 Mar. 2012, https://iecexplore.ieee.org/abstract/document/6181217). None of these methods leverage the unique advantages offered by LEO satellite systems, in particular the geometric diversity for rapid resolution of cycle ambiguities.

### SUMMARY

This Summary introduces a selection of concepts in simplified form that are described further below in the Detailed Description. This Summary neither identifies key or essential features, nor limits the scope, of the claimed subject matter.

There is a considerable need for determining attitude and precise position of mobile platforms, preferably without requiring a long calibration time while the platforms remain stationary. Described herein is a technique for using phased array antennas for Low Earth Orbit (LEO) satellite systems to determine the precise orientation of the antenna platform. This technique allows a phased array antenna to be placed on mobile platforms or vehicles, such as cars or drones, and enables those phased array antennas to place directional high-gain beams on satellites for robust high bandwidth communication, such as required for a high-quality video. This technique involves carrier-phase tracking using multiple patches of the phased array antenna and solution of the mobile attitude equations including resolution of potential integer cycle ambiguities between the patches.

An example implementation of this approach is described herein for use with the Starlink satellite system. Also described herein is how the Starlink satellites, for example, can be used for precise differential positioning using carrier signals or modulation on the carrier signals. These techniques have particular application to mobile platforms such as motor vehicles, such as cars, which can use flat Starlink patch array antennas for ubiquitous high bandwidth internet connectivity, and unmanned aerial vehicles (UAVs), such as drones, that can use Starlink patch array antennas to eliminate the requirement for a local user controller, which limits their range based on the requirement to maintain robust communications with user controller. Using similar concepts, phased array antennas also can be used to maintain targeted beams between a mobile platform and a user terminal.

Accordingly, in one aspect, a method includes receiving, by a phased array antenna for a platform, one or more carrier signals. Carrier phase of the received one or more carrier signals is tracked. One or more processing elements for the platform resolve one or more integer cycle ambiguities for one or more baselines associated with the phased array antenna. The one or more processing elements solve one or more orientation parameters based on the one or more integer cycle ambiguities. The one or more orientation parameters describe orientation of the phased array antenna.

In one aspect, an apparatus includes a phased array antenna receiving one or more carrier signals. The apparatus further includes a receiver performing carrier phase tracking of the one or more carrier signals received by the phased array antenna. The apparatus further includes one or more processing elements programmed to resolve one or more integer cycle ambiguities for one or more baselines associated with the phased array antenna. The one or more processing elements further solves one or more orientation parameters based on the one or more integer cycle ambiguities. The one or more orientation parameters describe orientation of the phased array antenna.

In one aspect, a system includes a set of satellites configured to transmit one or more carrier signals and a mobile platform. The mobile platform includes a phased array antenna attached to the mobile platform and configured to receive one or more of the one or more carrier signals from the set of transmitters. The mobile platform has a computing entity programmed to perform carrier phase tracking of the one or more carrier signals received by the phased array antenna. The computing entity further resolves one or more integer cycle ambiguities for one or more baselines associated with the phased array antenna. The computing entity further solves one or more orientation parameters based on the one or more integer cycle ambiguities. The one or more orientation parameters describe orientation of the phased array antenna. The mobile platform can cause a change in the orientation of the phased array antenna based on the solved one or more orientation parameters to direct transmission of data from the mobile platform to the set of satellites.

In one aspect, an apparatus includes a mobile platform and a phased array antenna affixed to the mobile platform. The phased array antenna supports communication between the mobile platform and a plurality of satellites. In some implementations, the mobile platform includes one or more processing elements programmed to track carrier phase, resolve integer cycle ambiguities for multiple baselines in the phased array antenna, and solve parameters describing orientation of the mobile platform. The antenna can be oriented such that directional beams can be placed on multiple satellites.

In one aspect, a method for using satellites to orient a phased array antenna on a platform involves tracking carrier phase, resolving integer cycle ambiguities for multiple baselines in the phased array antenna, and solving parameters describing orientation of the platform.

In one aspect, an apparatus for using satellites to orient a phased array antenna on a platform includes means for tracking carrier phase. The apparatus further comprises means for resolving integer cycle ambiguities for multiple baselines in the phased array antenna. The apparatus further comprises means for solving parameters describing orientation of the platform.

In one aspect, a method for terrestrial communication between a mobile platform and a stationary platform uses one or more directional phased array antennas located at the stationary platform, or at the mobile platform, or both at the stationary platform and at the mobile platform.

In one aspect, a system for terrestrial communication between a mobile platform and a stationary platform uses one or more directional phased array antennas located at the stationary platform, or at the mobile platform, or both at the stationary platform and at the mobile platform.

In one aspect, a method for terrestrial communication between a mobile platform and a stationary platform includes orienting phased array antennas located at the mobile platform to communicate with a stationary platform.

In one aspect, a system for terrestrial communication between a mobile platform and a stationary platform includes means for orienting phased array antennas located at the mobile platform to communicate with a stationary platform.

In any of the foregoing aspects, by having a mobile platform, such as a drone, with the capability of orienting its phased array antenna, such as a STARLINK antenna, such that directional beams can be placed by the mobile platform on multiple satellites, high bandwidth video streams can be transmitted in a way that eliminates the need for transmission from the drone to a terrestrial base station (as otherwise used in the system as described in PCT Publication WO2021/231584 A1).

In any of the foregoing aspects, the one or more carrier signals can include a plurality of carrier signals. A carrier signal can be received from a satellite. A carrier signal can be received from a terrestrial base station. Tracking carrier phase can include determining a difference between received carrier signals.

In any of the foregoing aspects, resolving one or more integer cycle ambiguities for one or more baselines associated with the phased array antenna can include resolving integer cycle ambiguities for multiple baselines associated with the phased array antenna.

Any of the foregoing aspects can include changing orientation of the phased array antenna based on the one or more solved orientation parameters.

Any of the foregoing aspects can include one or more of the following features. The platform comprises one or more stationary platforms. The platform comprises a single stationary platform. The platform comprises a plurality of stationary platforms. The platform comprises one or more mobile platforms. The platform comprises a single mobile platform. The platform comprises a plurality of mobile platforms. The platform comprises a combination of one or more stationary platforms and one or more mobile platforms. In some implementations, the mobile platform comprises a drone or an unmanned aerial vehicle. In some implementations, the mobile platform comprises a car or an automobile or other ground vehicle. In some implementations, the stationary platform comprises a terrestrial base station. In some implementations, the stationary platform comprises a base station with a user terminal. In some implementations, a communications link is provided between the stationary platform and the mobile platform. In some implementations, the communication link is provided between a user terminal and a phased array antenna on the mobile platform.

Any of the foregoing aspects can include one or more of the following features. The satellites include one or more navigation satellites. The satellites include one or more low earth orbit satellites. The low earth orbit satellites comprises a constellation of low earth orbit satellites. In some implementations the constellation of low earth orbit satellites comprises STARLINK satellites. In some implementations, the phased array antenna comprises a STARLINK phased array antenna.

Any of the foregoing aspects can include one or more of the following features. Solving the one or more orientation parameters is based at least in part on wide-laning one or more carrier frequencies from a common transmitter. In some implementations, solving the one or more orientation parameters uses wide-laning of multiple Starlink satellite signals at different frequencies. In some implementations, the one or more received carrier signals can be at different frequencies, and the one or more processing elements can be further programmed to solve the one or more orientation parameters based at least in part on wide-laning one or more carrier frequencies from a common transmitter.

Any of the foregoing aspects can include one or more of the following features. Precise differential 3-D location of a mobile platform is performed by extracting time of arrival of modulation sequences at a reference antenna and mobile antenna. In some implementations, using Starlink satellites, differential 3-D location of a mobile platform is performed by extracting time of arrival of Starlink modulation sequences at a reference and mobile antenna. In some implementations with a mobile platform, one or more processing elements for the mobile platform can be further programmed to determine one or more time of arrival modulation sequences for the phased array antenna and for a user terminal. A three-dimensional location of the phased array antenna can be determined based on the one or more time of arrival modulation sequences for the phased array antenna and for the user terminal.

Any of the foregoing aspects may be embodied as a computer system, as any individual component of such a computer system, as a process performed by such a computer system or any individual component of such a computer system, or as an article of manufacture including computer storage in which computer program code is stored and which, when processed by the processing system(s) of one or more computers, configures the processing system(s) of the one or more computers to provide such a computer system or individual component of such a computer system.

The following Detailed Description references the accompanying drawings which form a part of this application, and which show, by way of illustration, specific example implementations. Other implementations may be made without departing from the scope of the disclosure.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 shows an example operational overview for orienting a phased array antenna on a mobile platform (e.g., a vehicle such as a drone or car), in accordance with some example embodiments described herein.

FIG. 2 depicts an example coordinate system for a single rotation, in accordance with some example embodiments described herein.

FIG. 3 shows an example operational overview for differential carrier phase and/or code phase positioning, in accordance with some example embodiments described herein.

FIG. 4 shows an example operational overview for establishing a terrestrial communication link between an antenna on a mobile platform (e.g., a vehicle such as a drone or car) and a base station, in accordance with some example embodiments described herein.

FIG. 5 provides an example apparatus in accordance with some embodiments described herein.

### DETAILED DESCRIPTION

There is a considerable need for determining attitude and precise position of mobile platforms, preferably without requiring a long calibration time while the platforms remain stationary. Described herein is a technique for using phased array antennas for Low Earth Orbit (LEO) satellite systems to determine the precise orientation of the antenna platform. This technique allows a phased array antenna to be placed on mobile platforms or vehicles, such as cars or drones, and enables those phased array antennas to place directional high-gain beams on satellites for robust high bandwidth communication, such as required for a high-quality video. This technique involves carrier-phase tracking using multiple patches of the phased array antenna and solution of the mobile attitude equations including resolution of potential integer cycle ambiguities between the patches.

An example implementation of this approach is described for use with the Starlink satellite system. Also described is how the Starlink satellites, for example, can be used for precise differential positioning using carrier signals or modulation on the carrier signals. These techniques have particular application to mobile platforms such as motor vehicles, such as cars, which can use flat Starlink patch array antennas for ubiquitous high bandwidth internet connectivity, and unmanned aerial vehicles (UAVs), such as drones, that can use Starlink patch array antennas to eliminate the requirement for a local user controller, which limits their range based on the requirement to maintain robust communications with user controller. Using similar concepts, phased array antennas also can be used to maintain targeted beams between a mobile platform and a user terminal.

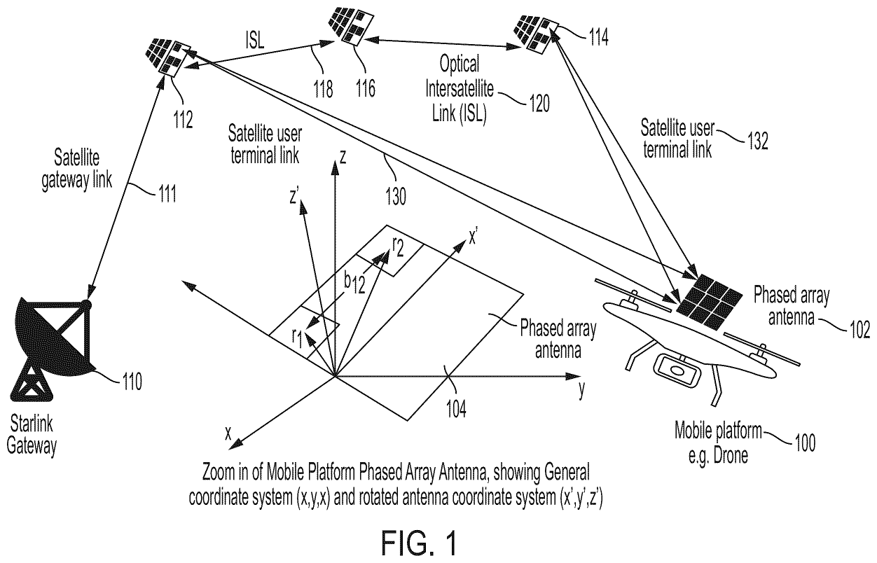

The following section describes how the geometric diversity of the satellites can also be used to resolve attitude of a phased array antenna. The following section also describes how one can use the modulation, rather than the carrier phase, on the satellite communication signal for precise navigation in a differential positioning system, which could then be used to seed the system for more precise carrier phase navigation.

Whereas in applications where a receiver and a reference are separated and driven by separate clocks, and an additional satellite is needed to resolve attitude along with clock, in the case of attitude with receivers sharing the same clock, only two satellites are needed so long as the separation between two antennas is known in some embodiments described herein. FIG. 1 describes this scenario, where all the patches of a phased array antenna 102 on a mobile platform 100 (e.g., a drone) are assumed to feed a receiver which is driven by a single clock source. In order to illustrate the coordinate transformations, the antenna on the mobile platform is blown up in the image (at 104) and associated with its own local Cartesian coordinate system.

In FIG. 1, a gateway 110, such as a STARLINK gateway, communicates with a first satellite 112 over gateway link 111. The first satellite communicates with a second satellite 114, such as through a third satellite 116, and optical intersatellite links (ISL) 118 and 120. The mobile platform 100 communicates with two satellites, e.g., the first satellite 112 and the second satellite 114, over satellite user terminal links 130 and 132, respectively.

Mathematics of resolving the orientation of the phased array antenna 102 on the mobile platform 100 as shown in FIG. 1 will now be explained. Assume for satellite s we have a phase measurement at each antenna element, or patch γₛᵢ, i=1 . . . . N. Whereas just one patch can be used as the reference, that can amplify the noise at that patch, so instead assume that we difference the phase from every patch to every other patch to form N(N−1)/2 measurements of the form Δγₛᵢⱼ=γₛᵢ−γₛⱼ. We describe the difference in distance that the satellite wave front travels between two patches:

$$Δ {d}_{s i j} = λ ( Δ {γ}_{s i j} + {l}_{s i j} )$$

Here, λ is wavelength and lₛᵢⱼ is the integer cycle ambiguity for satellite s between two patches, since phase can only be measured modulo 2π. We cannot directly measure lₛᵢⱼ but it can be computed, particularly in systems with geometric diversity from fast moving satellites, as discussed later. Let the position of each patch in the local coordinate system of the antenna be rᵢ=[xᵢ yᵢ zᵢ]^{T}. We can then define M=N(N−1)/2 baseline vectors which connect each of the patches rᵢⱼ=rᵢ−rⱼ in the antennas coordinate system. Let 1ₛ be the unit vector in the direction of satellite s in the local coordinate system of the antenna. The satellites are far enough away that 1ₛ is the same for all patches. We can describe Δdₛᵢⱼ in terms of the projection of the baseline vectors onto the satellite direction vectors:

Δdₛᵢⱼ=rᵢⱼ^{T}1ₛ

A rotation matrix R may be defined and can translate vectors in the general coordinate system, which we denote with ′, to the local coordinate system of the antenna for example rᵢ=Rrᵢ′. This transformation can be defined in terms of a rotation ψ (heading) around the general z axis, followed by a rotation θ (pitch) around the newly formed y axis, followed by another rotation ϕ (yaw) around the newly formed x axis. In order to compute the full rotation matrix R, take these rotations one step at a time. It can be shown using trigonometric identities that after the first rotation, the coordinates transform according to:

$$[ \begin{matrix}{x}_{i} \\ {y}_{i} \\ {z}_{i}\end{matrix} ] = [ \begin{matrix}cos ψ & sin ψ & 0 \\ - sin ψ & cos ψ & 0 \\ 0 & 0 & 1\end{matrix} ] [ \begin{matrix}{x}_{i}^{′} \\ {y}_{i}^{′} \\ {z}_{i}^{′}\end{matrix} ]$$

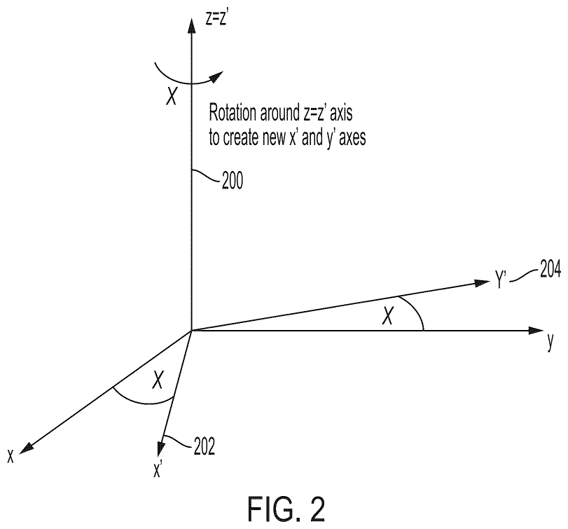

FIG. 2 illustrates this rotation around z=z′ axis (200) in order to generate axes x′ (202) and y′ (204) of a new coordinate system. Applying this same approach to the three rotations by swapping in the relevant axis and applying the same principal, we can define the vector in the new coordinate system that is local to the antenna:

$${r}_{i} = [ \begin{matrix}{x}_{i} \\ {y}_{i} \\ {z}_{i}\end{matrix} ] = [ \begin{matrix}cos ψ & sin ψ & 0 \\ - sin ψ & cos ψ & 0 \\ 0 & 0 & 1\end{matrix} ] [ \text{} \begin{matrix}cos θ & 0 & sin θ \\ 0 & 1 & 0 \\ - sin ψ & 0 & cos θ\end{matrix} ]$$

$$[ \text{} \begin{matrix}1 & 0 & 0 \\ 0 & cos ϕ & sin ϕ \\ 0 & - sin ϕ & cos ϕ\end{matrix} ] [ \text{} \begin{matrix}{x}_{i}^{′} \\ {y}_{i}^{′} \\ {z}_{i}^{′}\end{matrix} ] \text{} = {Rr}_{i}^{′}$$

Multiplying out the matrices, we find

$$R ( \text{} Θ ) = [ \text{} \begin{matrix}cos θ cos ψ & cos θ sin ψ & - sin θ \\ \begin{matrix}- cos ϕsinψ + \\ sin ϕ sin θ cos ψ\end{matrix} & \begin{matrix}cos ϕ cos ψ + \\ sin ϕsinθ sin ψ\end{matrix} & sin ϕ cos θ \\ \begin{matrix}sin ϕ sin ψ + \\ cos ϕsin θ cos ψ\end{matrix} & \begin{matrix}- sin ϕ cos ψ + \\ cos ϕ sin θ sin ψ\end{matrix} & cos ϕcos θ\end{matrix} \text{} ]$$

The vector Θ=[Ø θ ψ]^{T} captures the three angles that determine R. If the unit vector the satellites in the general coordinate system is 1ₛ′ such that 1ₛ=R1ₛ′, we can describe the measurements:

$$Δ {d}_{s i j} = {r}_{ij}^{T} R ( Θ ) {1}_{s}^{′} = λ ( Δ {γ}_{i j} + {l}_{i j} )$$

For simplicity, replace indices ij with index b=1 . . . . B where B=N(N−1)/2, the number of baselines between patches. The cost function for S satellites can now be written as

$$J ( Θ ) = {\sum }_{s = 1 … S} {\sum }_{b = 1 … B} {( λ ( Δ {γ}_{s b} + {l}_{s b} ) - {r}_{b}^{T} R ( Θ ) {1}_{s}^{′} )}^{2}$$

We minimize this cost function by finding an iterative solution by iteratively updating Θ by the incremental vector

$$δΘ = [ \begin{matrix}δϕ \\ δθ \\ δψ\end{matrix} ]$$

A new rotation matrix may be defined according to δΘ:

$$R ( Θ ) \to R ( Θ + δΘ ) \approx R ( Θ ) + δ R ( Θ )$$

To find δR(Θ), the derivatives of R(Θ) with respect to each of the angles are determined as follows:

$$\frac{dR}{d ∅} = [ \begin{matrix}0 & 0 & 0 \\ sin ∅sinψ + cos ∅sinθcosψ & - s in ∅cosψ + cos ∅sinθsinψ & cos ∅cosθ \\ cos ∅sinψ - sin ∅sinθcosψ & cos ∅cosψ - sin ∅sinθsinψ & - s in ∅cosθ\end{matrix} ]$$

$$\frac{dR}{d θ} = [ \begin{matrix}- sin θcosψ & - sin θsinψ & - cos θ \\ sin ∅cosθcosψ & sin ∅cosθsinψ & - s in ∅sinθ \\ cos ∅cosθcos & cos ∅cosθsinψ & cos ∅sinθ\end{matrix} ]$$

$$\frac{d R}{d ψ} = [ \begin{matrix}- cos θsinψ & cos θcosψ & 0 \\ - cos ∅cosψ - sin ∅sinθsinψ & - cos ∅cosψ + sin ∅sinθcosψ & 0 \\ sin ∅cosψ - cos ∅sinθsinψ & sin ∅sinψ + cos ∅sinθcosψ & 0\end{matrix} ]$$

Hence, δR(Θ) may be expressed as:

$$δ R ( Θ ) = \frac{d R}{d ∅} δ ∅ + \frac{d R}{d θ} δ θ + \frac{d R}{d ψ} δ ψ$$

The next iteration of the cost function is approximately

$$J ( Θ + δΘ ) \approx {\sum }_{s = 1 … S} {\sum }_{b = 1 … B} {( λ ( Δ {γ}_{s b} + {l}_{s b} ) - {r}_{b}^{T} [ R ( Θ ) + \frac{d R}{d ∅} δ ∅ + \frac{d R}{d θ} δ θ + \frac{d R}{d ψ} δ ψ ] {1}_{s}^{′} )}^{2} = {\sum }_{s = 1 … S} {\sum }_{b = 1 … B} {( {e}_{s b} + λ {l}_{s b} - {r}_{b}^{T} [ \frac{d R}{d ∅} δ ∅ + \frac{d R}{d θ} δ θ + \frac{d R}{d ψ} δ ψ ] {1}_{s}^{′} )}^{2} = {\sum }_{s = 1 … S} {\sum }_{b = 1 … B} {( {e}_{s b} + λ {l}_{s b} - {r}_{b}^{T} [ \frac{d R}{d ∅} {1}_{s}^{′} \frac{d R}{d θ} {1}_{s}^{′} \frac{d R}{d ψ} {1}_{s}^{′} ] δθ )}^{2}$$

Where e_{sb}=λ(Δγ_{sb}+l_{sb})−r_{b}^{T}R(Θ) indicates the error in the last iteration. The cost can now be represented in stacked matrix form:

$$J ( Θ + δΘ ) = {‖ e - H ( Θ ) δΘ ‖}_{2}^{2}$$

Where e is a BS×1 vector and H is a SB×3 matrix defined as:

$$e = [ \begin{matrix}{e}_{11} \\ ⋮ \\ {e}_{SB}\end{matrix} ] , H ( Θ ) = [ \begin{matrix}{r}_{1}^{T} [ \begin{matrix}\frac{dR}{d ∅} {1}_{1}^{′} & \frac{dR}{d θ} {1}_{1}^{′} & \frac{dR}{d ψ} {1}_{1}^{′}\end{matrix} ] \\ {r}_{B}^{T} [ \begin{matrix}\frac{d R}{d ∅} {1}_{S}^{′} & \frac{d R}{d θ} {1}_{S}^{′} & \frac{d R}{d ψ} {1}_{S}^{′}\end{matrix} ]\end{matrix} ]$$

Which can be solved as:

$$δΘ = {( {H ( Θ )}^{T} H ( Θ ) )}^{- 1} {H ( Θ )}^{T} e$$

Hence the estimate for Θ can be solved iteratively, until convergence where δΘ approaches 0. We now incorporate the fact that the cost J is also a function of SB integer cycle ambiguities l_{sb}, s=1 . . . . S, b=1 . . . . B which we will lump into the set L=[l₁₁ . . . l_{SB}]^{T} and which we include as a variable to optimize in the cost J(Θ, L). One can resolve the integers l_{sb} by performing an integer search, constraining the integers such that |lₛₘ|≤|Δdₛₘ/λ|, solving the iteration above to find the optimal Θ_{L} for each chosen set of integers L, and picking that set L which minimize the cost J(Θ_{L}, L). This can work when the antenna dimensions are small relative to λ but in general this snapshot solution at one moment in time is not well-determined and not as reliable as motion-based solutions.

In order to achieve a robust resolution of L, one requires geometric diversity which can be achieved by either rotating the platform or allowing the satellites to move. In the case of a low-earth orbit system such as Starlink, a mobile platform, such as a drone, can move or remain motionless and cycle ambiguities can be resolved in under a minute. We will explore the general case when the drone is moving. Redefine the cost function in terms of a unique Θ at each discrete sampling time, Θₜ, t=1 . . . . T.

$$J ( {Θ}_{1} , … , {Θ}_{T} , L ) = {\sum }_{t = 1 … T} {\sum }_{s = 1 … S} {\sum }_{b = 1 … B} {( λ ( Δ {γ}_{sb , t} + {l}_{s b} ) - {r}_{b}^{T} R ( {Θ}_{t} ) {1}_{s , t}^{′} )}^{2}$$

As above, we iterate on each of the Θₜ to minimize the cost. At each iteration

$$J ( {Θ}_{1} + {δΘ}_{1} , … , {Θ}_{T} + {δΘ}_{T} , L ) = {\sum }_{t = 1 … T} {\sum }_{s = 1 … S} {\sum }_{b = 1 … B} {( λ ( Δ {γ}_{sb , t} + {l}_{s b} ) - {r}_{b}^{T} R ( {Θ}_{t} + {δΘ}_{t} ) {1}_{s , t}^{′} )}^{2} = {\sum }_{t = 1 … T} {\sum }_{s = 1 … S} {\sum }_{b = 1 … B} {( {e}_{sb , t} + λ {l}_{s b} - {r}_{b}^{T} [ \begin{matrix}\frac{d {R}_{t}}{d {∅}_{t}} {1}_{s}^{′} & \frac{d {R}_{t}}{d {θ}_{t}} {1}_{s}^{′} & \frac{d {R}_{t}}{d {ψ}_{t}} {1}_{s}^{′}\end{matrix} ] {δΘ}_{t} )}^{2}$$

where e_{sb,t}=λΔγ_{sb,t}−r_{b}^{T}R(Θₜ) now excludes the integers l_{sb}, which are explicitly estimated. The cost can be represented by stacking measurements in matrix form. L is constant across time, whereas a separate orientation is resolved at each time. Define the (3T+B)×1 vector of variables to be resolved:

$$X = [ \begin{matrix}{Θ}_{1} \\ ⋮ \\ {Θ}_{T} \\ L\end{matrix} ]$$

For now, estimate the integers L as continuous variables. At each iteration, we iteratively update X with:

$$δ X = [ \begin{matrix}{δΘ}_{1} \\ ⋮ \\ {δΘ}_{T} \\ δ L\end{matrix} ]$$

To minimize the cost:

$$J ( {Θ}_{1} + {δΘ}_{1} , … , {Θ}_{T} + {δΘ}_{T} , L + δ L ) = J ( X + δ X ) = {‖ E - H δ X ‖}_{2}^{2}$$

where:

$$E = [ \begin{matrix}{e}_{11 , 1} \\ ⋮ \\ {e}_{SB , 1} \\ ⋮ \\ {e}_{11 , T} \\ ⋮ \\ {e}_{SB , T}\end{matrix} ] , H = [ \begin{matrix}H ( {Θ}_{1} ) & 0 & 0 & - λ I \\ 0 & ⋱ & 0 & - λ I \\ 0 & 0 & H ( {Θ}_{1} ) & - λ I\end{matrix} ]$$

for which we can find the iterative solution as:

$$δ X = {( {H}^{T} H )}^{- 1} {H}^{T} E$$

until convergence when δX tends towards 0. The integer solutions can be rounded to the nearest value or they can be left as continuous variables. Additionally, or alternatively, other integer search algorithms may be used to resolve cycle ambiguities. For instance, some robust approaches exist for resolving cycle ambiguities as described in Rabinowitz 2000, pages 59-72, hereby incorporated by reference, which use efficient integer search algorithms. It will be clear to one skilled in the art, after reading the instant disclosure, how these or other approaches can be adapted to the problem addressed here.

Since all patches are on the same clock and the baseline between patches is known a priori, absent integer cycle ambiguity, only two satellites (e.g., first and second satellites 112 and 114) are needed to resolve orientation of a baseline. Since the orientation of any two baselines is needed to orient the antenna, the antenna orientation can be solved by two satellites. In order to resolve the cycle ambiguities, three satellites are needed. Thereafter, orientation can be resolved with two satellites so long as phase lock is maintained. If carrier phase can be measured to within one percent (1%) and the baseline is equal to or longer than λ, platform orientation angles can be resolved to a few percent or better, depending on the geometric dilution of precision from the orientation of the satellites and multipath errors which may not be common mode between patches.

### Suitability of Starlink

While little information has been made available by SpaceX about their Starlink constellation, certain key information can be determined from their public government filings. Imperfection in this information does not change or undermine the concepts of this invention. According to an October 2019 submission by the Federal Communication Commission to the International Telecommunication Union for spectrum, Starlink plans to launch approximately 42,000 spacecraft. At least 4,408 will be at an altitude of roughly 550 kilometers (km) (See FCC Report, “Application for Blanket Licensed Earth Stations”, 2019. https://fcc.report/IBFS/SES-LIC-INTR2019-00217/1616678, and Wikipedia, “Starlink”, Updated Jun. 1, 2022. https://en.wikipedia.org/wiki/Starlink). At least 85% of the satellites will be at an altitude below 400 km, roughly at 350 km (See SpaceX (Space Explorations Holdings, LLC), “APPLICATION FOR APPROVAL FOR ORBITAL DEPLOYMENT AND OPERATING AUTHORITY FOR THE SPACEX GEN2 NGSO SATELLITE SYSTEM”, May 26, 2020, https://fcc.report/IBFS/SAT-LOA-20200526-00055/2378669.pdf, hereinafter “SpaceX 2020”)—we will assume this is the remaining 37,592 satellites. The satellites will use Ku band for downlink to the user terminal including 10.7-12.75 GHz, 17.8-18.6 GHz, 18.8-19.3 GHZ, 19.7-20.2 GHz and Telemetry and Control (TC) downlinks of 12.15-12.25 GHz and 18.55-18.60 GHz. Assuming a minimum elevation of the satellites of forty (40) degrees (See SpaceX 2020 and Cakaj, Shkelzen, “The Parameters Comparison of the “Starlink” LEO Satellites Constellation for Different Orbital Shells”, Front. Comms. Net., 7 May 2021, https://doi.org/10.3389/frcmn.2021.643095), the area of the footprint covered by each of the 550 km satellites will be 1.6e6 km² and the area of footprint covered by the 350 km satellites would be 0.7e6 km². Assuming conservatively that the satellites are equally distributed around the world, the average number of 550 km and 350 km satellites potentially visible for a user will be roughly 4.8 and 16.6, respectively. While these numbers will depend heavily on the beam configuration, it is highly probable that 3 or more satellites will be available for precise attitude determination.

For Starlink downlink frequencies, using the TC bands as an example, with approximate frequencies of 12.15 GHz and 18.55 GHz, the associated wavelengths are approximately 2.5 cm and 1.6 cm. These wavelengths should enable millimeter-level positioning of each patch. Assuming the Starlink antennas are separated by far more than λ, orientation accuracy should be better than of a few percent. Note that the system can also use wide-laning (Sec Geng, Jianghui, “Triple-frequency GPS precise point positioning with rapid ambiguity resolution”, Journal of Geodesy, volume 87, pages 449-460 (2013), hereby incorporated by reference), where multiple frequencies are digitally combined to provide mixed frequencies that are the difference between the combined frequencies. If for example, a satellite's downlink is used with a signal at both 10.7 GHz and 12.15 GHz, the difference between these two frequencies will have a wavelength of 21.5 cm similar to GPS L1 signal. Depending on the signals available, one may use the frequencies closest together for the longest wavelengths and easiest cycle ambiguity resolution, and the use of multiple different frequencies could enable integers at each frequency to be unambiguously resolved with a snapshot solution not requiring geometric diversity. Although described above with respect to Starlink satellites, it will be appreciated by one of skill in the art that any LEO satellite may be used in addition to, in lieu of, or in combination with, one or more Starlink satellites.

### Positioning in 3D Space Using the Satellite Data Link

It has been described how differential carrier phase positioning can be achieved using LEOs to achieve centimeter-level positioning by resolving the integer cycle ambiguities based on satellite motion (See Rabinowitz, 2000). This system uses four Starlink satellites to resolve three position coordinates and one clock offset between reference and user. Fewer Starlink satellites could be used if the system is combined with GPS, as one only requires a subset of satellites to provide geometric diversity by rapid motion for resolution of cycle ambiguities. Here, we describe how the Starlink data link can also be used for navigation. Given the high data rates of Starlink, up to 100 Mbps on the downlink, the modulation on Starlink will have a symbol rate, or modulation bandwidth, substantially higher than GPS, hence higher positioning accuracy can be achieved, since signal timing accuracy is roughly linearly related to modulation bandwidth.

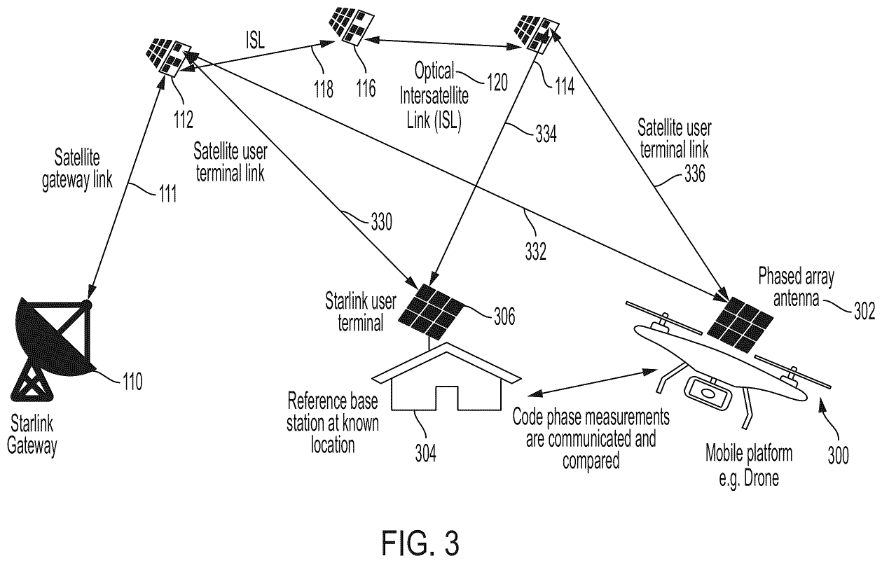

FIG. 3 illustrates a differential navigation system using Starlink. The phased array of the user terminal 306 at the reference base station 304 must measure the same Starlink signals (as indicated at 330, 332 and 334, 336) as the phased array antenna 302 on mobile platform 300. The constellation of satellites is shown as similar to those in FIG. 1. These signals may then be differenced to remove common-mode errors as is well understood in the art. Either a navigation signal can be embedded in the satellite transmission at positions that are known by the reference and mobile platform, for example following some established data sequence, or any sequence of downlink data can be captured by the mobile platform, time-stamped according to the local clock and conveyed to the reference. The signal at the reference will then be correlated against that captured at the mobile platform to determine the difference in time of arrival between the reference and mobile platform, which can be used to determine position and clock offset using known techniques. Note that rather than use a sequence of random data, which will have spurious statistically defined correlation peaks, it is better to use a known pseudo-noise sequence well suited to navigation, such as Gold codes used in Code Division Multiple Access Systems or C/A codes used in GPS.

### Orientation of Phased Array Antenna Using Geometric Diversity Provided by Mobile Platform

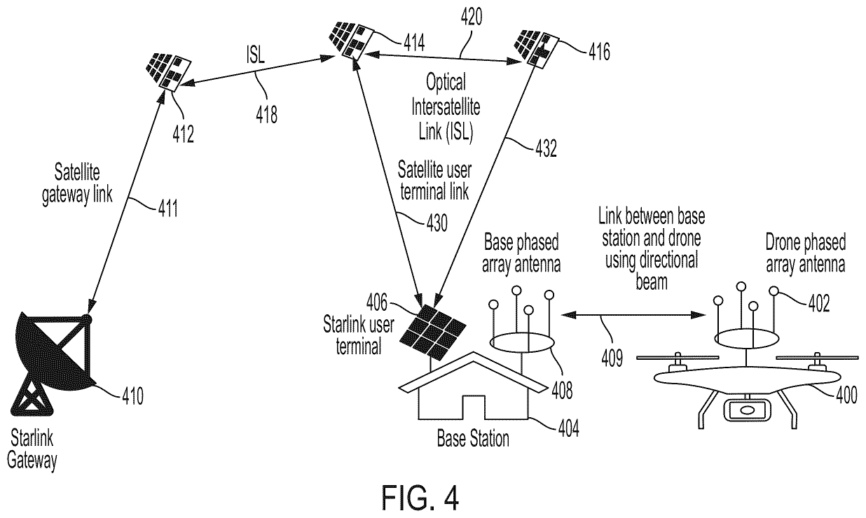

Note that for resolution of the orientation of a phased array antenna, one can also use motion provided by a mobile platform, such as drone or car, with respect to a reference station. FIG. 4 illustrates a scenario where a phased array antenna (402 or 408, respectively) is used at the mobile platform 400 or at the base station 404, or at both locations, in order to provide high directional gain to increase the range, speed or robustness of a communication link 409 between the base station 404 and the mobile platform 400.

In FIG. 4, a gateway 410, such as a STARLINK gateway, communicates with a first satellite 412 over gateway link 411. The first satellite communicates with additional satellites, such as a second satellite 414 and third satellite 416, through optical intersatellite links (ISL) 418 and 420. A base station 404 communicates with two of the satellites, e.g., the second satellite 414 and the third satellite 416, over satellite user terminal links 430 and 432, respectively.

In FIG. 4, since the direction of the communication link 409 will be closer to horizontal, and will require omni-directionality on the horizontal plane, each element of the phased array antenna can be constructed from a dipole—or other horizontally radiating antenna—rather than necessarily using a patch antenna. If the mobile platform—which we will assume is a drone—has a phased array antenna, it may move around the location of the base station antenna in order to provide sufficient geometric diversity for resolution of cycle ambiguities and orientation of the mobile platform, as described by the mathematics above. The drone may rotate around the three coordinate axes in order to provide sufficient geometric diversity to resolve cycle ambiguities and orient the mobile platform, as described by the mathematics above. If the mobile platform is assumed to be horizontal and the communication link between the mobile platform and the base station is also assumed to be roughly on the horizontal plane, one only needs to resolve one angle, namely the heading on the horizontal plane in order to resolve the orientation of the platform. This would use the same mathematical formalism as above, except that rather than create R(Θ) using 3 angles, one would simply use R(ψ) which captures a coordinate transformation for a rotation around the z-axis, where the z axis is assumed to be vertical.

$$R ( ψ ) = [ \begin{matrix}cos ψ & sin ψ & 0 \\ - s in ψ & cos ψ & 0 \\ 0 & 0 & 1\end{matrix} ]$$

Using the same mathematical approach described above, in this horizontal scenario, one could resolve cycle ambiguities and platform heading using only a signal transmitter, either by flying around the transmitter or rotation the drone in the horizontal plane.

In the case that the base station 404 has a phased array antenna 408, once the location of the mobile platform 400 is known, a directional beam can be generated by base station directed towards the drone to maximize communication bandwidth and robustness. In the case that the mobile platform 400 has a phased array antenna 402, once the position and orientation of the mobile platform 400 is known relative to the base station 404, a directional beam can be generated by the mobile platform 400 directed towards the base station 404. Once the required direction of a beam is known, the techniques for phase-shifting signals feeding each array of a phased array antenna in order to generate a direction is well understood in the art. One can also use an adaptive beam-forming algorithm to track the drone from the base station with a directional beam (See, for example, Rabinowitz 2000, pages 141-150, hereby incorporated by reference).

Such techniques can be used within a system such as described in PCT Publication WO2021/231584 A1, entitled “Systems and Methods to Preserve Wildlife and Enable Remote Wildlife Tourism”, filed 12 May 2021, which is hereby incorporated by reference, to eliminate the need for transmission of video from a drone to a terrestrial base station.

### Example Computing Entity

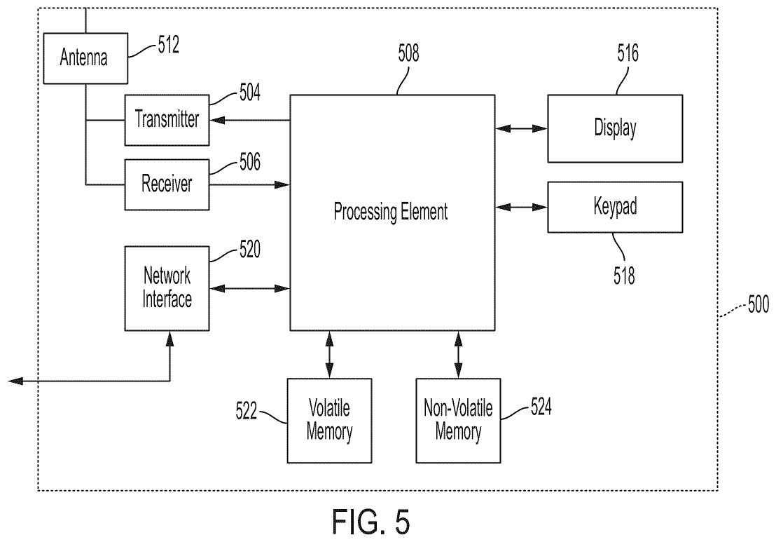

FIG. 5 provides an illustrative schematic representative of an example computing entity 500 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. Computing entity 500 can be operated by various parties.

As shown in FIG. 5, the computing entity 500 can include an antenna 512, a transmitter 504 (e.g., radio), a receiver 506 (e.g., radio), and a processing element 508 (e.g., CPLDs, microprocessors, multi-core processors, coprocessing entities, ASIPs, microcontrollers, and/or controllers) that provides signals to and receives signals from the transmitter 504 and receiver 506, correspondingly.

The signals provided to and received from the transmitter 504 and the receiver 506, correspondingly, may include signaling information/data in accordance with air interface standards of applicable wireless systems. In this regard, the computing entity 500 may be capable of operating with one or more air interface standards, communication protocols, modulation types, and access types. More particularly, the computing entity 500 may operate in accordance with any of a number of wireless communication standards and protocols. In a particular embodiment, the computing entity 500 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the computing entity 500 may operate in accordance with multiple wired communication standards and protocols via a network interface 320.

Via these communication standards and protocols, the computing entity 500 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The computing entity 500 can also download changes, add-ons, and updates, for instance, to its firmware, software (e.g., including executable instructions, applications, program modules), and operating system.

According to one embodiment, the computing entity 500 may include location determining aspects, devices, modules, functionalities, and/or similar words used herein interchangeably. The location determining aspects can include the determination of orientation parameters as described herein to enable orientation of the phased array antenna on a mobile platform to direct a high-gain beam to satellites for robust high bandwidth communication, such as for a high-quality video streaming.

For example, the computing entity 500 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the computing entity's 500 position in connection with a variety of other systems, including cellular towers, Wi-Fi access points, and/or the like.

Similarly, the computing entity 500 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The computing entity 500 may also comprise a user interface (that can include a display 516 coupled to a processing element 508) and/or a user input interface (coupled to a processing element 508). For example, the user interface may be a user application, browser, user interface, and/or similar words used herein interchangeably executing on and/or accessible via the computing entity 500 to interact with and/or cause display of information/data from external computing entities. The user input interface can comprise any of a number of devices or interfaces allowing the computing entity 500 to receive data, such as a keypad 518 (hard or soft), a touch display, voice/speech or motion interfaces, or other input device. In embodiments including a keypad 518, the keypad 518 can include (or cause display of) the conventional numeric (0-9) and related keys (#, *), and other keys used for operating the computing entity 105 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The computing entity 500 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the computing entity 500. As indicated, this may include a user application that is resident on the entity or accessible through a browser or other user interface for communicating with various other computing entities. As will be recognized, these frameworks and descriptions are provided for exemplary purposes only and are not limiting to the various embodiments.

All documents cited herein, including patents, patent applications, and publications, are herein incorporated by reference in their entirety just as if each specific mention of the document had explicitly stated the document to be incorporated by reference in its entirety. The relevance of the material incorporated by reference to the present disclosure is to be understood from context, including the specific context in which the incorporated document was mentioned.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation. It should be understood that the disclosure herein contemplates any possible combination of the various embodiments described herein even if not explicitly exemplified, unless indicated otherwise, explicitly or by context (e.g., where various aspects would be understood to be physically incompatible).

It should be understood that the subject matter defined in the appended claims is not necessarily limited to the specific implementations described above. The specific implementations described above are disclosed as examples only.

What is claimed is:

1. A method, comprising:
receiving, by a phased array antenna for a platform, one or more carrier signals;
tracking carrier phase of the received one or more carrier signals;
resolving, by one or more processing elements for the platform, one or more integer cycle ambiguities for one or more baselines associated with the phased array antenna; and
solving, by the one or more processing elements, one or more orientation parameters based on the one or more integer cycle ambiguities, wherein the one or more orientation parameters describe orientation of the phased array antenna.

2. The method of claim 1, further comprising causing a change in the orientation of the phased array antenna based on the one or more solved orientation parameters.

3. The method of claim 2, wherein:
the one or more received carrier signals are at different frequencies, and
solving the one or more orientation parameters is based at least in part on wide-laning one or more carrier frequencies from a common transmitter.

4. The method of claim 3, wherein the platform comprises a mobile platform, the method further comprising:
determining, by the apparatus, one or more time of arrival modulation sequences for the phased array antenna and for a user terminal; and
performing, by the apparatus, three-dimensional location determination of the phased array antenna based on the one or more time of arrival modulation sequences for the phased array antenna and for the user terminal.

5. The method of claim 4, wherein one or more of the one or more carrier signals are received from one or more satellites.

6. The method of claim 4, wherein one or more of the one or more carrier signals are received from a user terminal associated with a reference base station.

7. The method of claim 1, wherein the platform comprises a drone.

8. An apparatus, comprising:
a phased array antenna receiving one or more carrier signals;
a receiver performing carrier phase tracking of the one or more carrier signals received by the phased array antenna; and
one or more processing elements programmed to:
resolve one or more integer cycle ambiguities for one or more baselines associated with the phased array antenna; and
solve one or more orientation parameters based on the one or more integer cycle ambiguities, wherein the one or more orientation parameters describe orientation of the phased array antenna.

9. The apparatus of claim 8, wherein the orientation of the phased array antenna is changed based on the one or more solved orientation parameters.

10. The apparatus of claim 9, wherein:
the one or more received carrier signals are at different frequencies, and
the one or more processing elements is further programmed to solve the one or more orientation parameters based at least in part on wide-laning one or more carrier frequencies from a common transmitter.

11. The apparatus of claim 10, wherein the apparatus comprises a mobile platform, and wherein the one or more processing elements is further programmed to:
determine one or more time of arrival modulation sequences for the phased array antenna and for a user terminal; and
determine three-dimensional location of the phased array antenna based on the one or more time of arrival modulation sequences for the phased array antenna and for the user terminal.

12. The apparatus of claim 11, wherein one or more of the one or more carrier signals are received from one or more satellites.

13. The apparatus of claim 11, wherein one or more of the one or more carrier signals are received from a user terminal associated with a reference base station.

14. The apparatus of claim 8, wherein the apparatus comprises a drone.

15. A system, comprising:
a set of satellites configured to transmit one or more carrier signals; and
a mobile platform comprising:
a phased array antenna attached to the mobile platform and configured to receive one or more of the one or more carrier signals from the set of transmitters;
a computing entity programmed to:
perform carrier phase tracking of the one or more carrier signals received by the phased array antenna;
resolve one or more integer cycle ambiguities for one or more baselines associated with the phased array antenna;
solve one or more orientation parameters based on the one or more integer cycle ambiguities, wherein the one or more orientation parameters describe orientation of the phased array antenna; and
cause a change in the orientation of the phased array antenna based on the solved one or more orientation parameters to direct transmission of data from the mobile platform to the set of satellites.
